(19) United States
(12) Patent Application Publication
(10) Pub. No.: US 2020/0086788 A1
(43) Pub. Date: Mar. 19, 2020

(54) METHOD AND SYSTEM FOR ALERTING DRIVERS WITH DIRECTION SPECIFIC AUDIO SYSTEM

(71) Applicant: Richard J. PIVNICKA, Woodside, CA (US)

(72) Inventor: Richard J. PIVNICKA, Woodside, CA (US)

(73) Assignee: Richard J. PIVNICKA, Woodside, CA (US)

(21) Appl. No.: 16/574,951

(22) Filed: Sep. 18, 2019

Related U.S. Application Data
(60) Provisional application No. 62/733,518, filed on Sep. 19, 2018.

(51) Int. Cl. B60Q 9/00; H04R 1/02; H04R 1/40; H04R 3/12

(52) U.S. Cl. CPC B60Q 9/008; H04R 1/025; G08G 1/16; H04R 3/12; H04R 1/403

(57) ABSTRACT

A direction specific audio alert system in the form of a speakers located in both sides of the head rest of the drivers vehicle seat besides speakers that already exist in front, left and right side of the driver in the vehicle is described. A system to make the alerts as a software module is also described.

### CROSS REFERENCE TO RELATED APPLICATION

This application claims priority to U.S. Provisional application 62733518 filed on Sep. 19, 2018. The instant application incorporates all the elements of the previous application in its entirety.

### FIELD OF TECHNOLOGY

This disclosure relates generally to the method and system for alerting drivers with specific audio devices embedded and programmed to alert drivers of other vehicles.

### BACKGROUND

At present there are autonomous vehicles, electric vehicles and regular vehicles that have a color coded dashboard based alert system that shows different colors and beeps different sounds when a vehicle or objects are close. The current technology also alerts to show how close the other vehicles are compared to the position of the driver's vehicle. They are very useful in alerting and indicating the distance. However, during rush hour and fast speeds it is difficult to access where the vehicles are. Drivers have to take their eye off of their road and look at the dash board of the vehicle to figure out where the collusion might happen. That creates more danger as people are already distracted with radio, cell phone calls and other occupants of the vehicle.

There is a need for a more robust, automated and immediate indication system and method to alert drivers so they don't have to take their eye of the wheel and road.

### SUMMARY

Several embodiments for a system and method to alert drivers using audio equipment that are specifically placed are described.

In one embodiment, the system contains several modules for integrating, coordinating and alerting the drivers are described. In one embodiment, a speaker embedded in the head rest of the driver on either side is described. The instant speaker is a small piezo electric speaker or any other small speaker that may be connected to the overall audio system or be separate just for alerting the driver of impending danger is described.

In one embodiment, the system enables the audio or radio of the vehicle to be muted when collusion danger is detected so the driver can clearly hear the oncoming alerts. In one embodiment, along with the existing alerting system of color bars on the dash board the alerting system may be integrated and a sound may be produced to alert the driver. In another embodiment, the severity of the alerts may use the same sound or different sounds are disclosed.

In one embodiment, the system with speakers may be customizable by the user as needed. In another embodiment, an end to end automated, integratable, and a platform agnostic alert system and method are disclosed.

Other features will be apparent from the accompanying drawings and from the detailed description that follows.

### BRIEF DESCRIPTION OF DRAWINGS

Example embodiments are illustrated by way of example and not limitation in the figures of the accompanying drawings, in which like references indicate similar elements and in which:

FIG. 1 shows the conventional alert system on dashboard of a vehicle.

FIG. 2 shows the lane departure alerts to the driver from the dash board.

FIG. 3. shows the position of the speakers on the right of the and left of the drivers head rest.

FIG. 4. shows a system for alerting drivers integrated into the vehicle software system.

FIG. 5 shows the different levels of colors for alerting proximity to the vehicle.

FIG. 6 shows an alert of oncoming vehicle and indicates to stop.

Other features of the present embodiments will be apparent from the accompanying drawings and from the detailed description that follows.

### DETAILED DESCRIPTION

Although the present embodiments have been described with reference to specific example embodiments, it will be evident that various modifications and changes may be made to these embodiments without departing from the broader spirit and scope of the various embodiments. The vehicle is a general term used for including, but not limited to, van, truck, aircraft, watercraft and other transportation vehicles.

A system and method to alert drivers using audio equipment that are specifically placed behind the drivers head rest on the right, left, front on either side of the dash board are described.

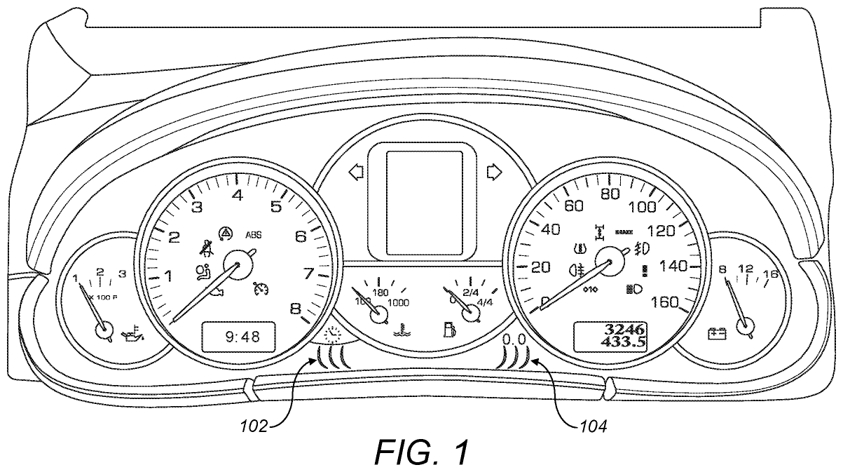

FIG. 1 shows the regular dash board with bar system 102 and 104 showing various color bars from red, orange and green depending on how far the object is from the instant vehicle. The driver looks at alerts on the dash board to figure out which direction is the alert for? The busy nature of the dash board even for an experienced driver can be very distracting. To solve this problem we have implemented two speakers on the head rest of the driver's seat to alert the rear object alerts using speaker specific (audio) directional alert.

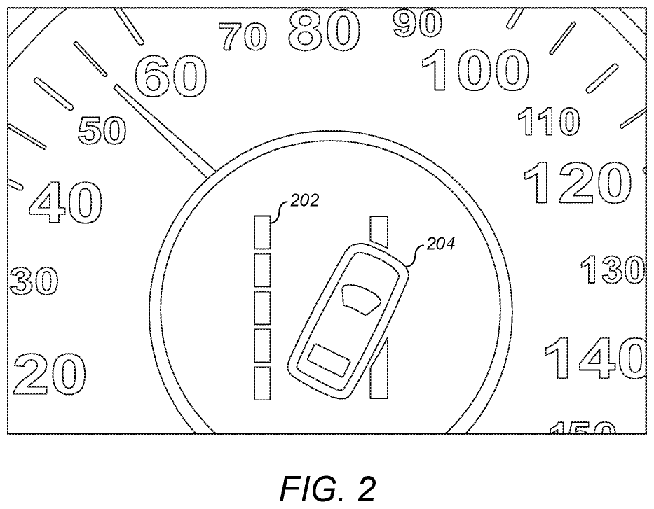

FIG. 2 shows a conventional lane departure alert 202 and 204 with visual and sound to the driver who has again to look at the dash board.

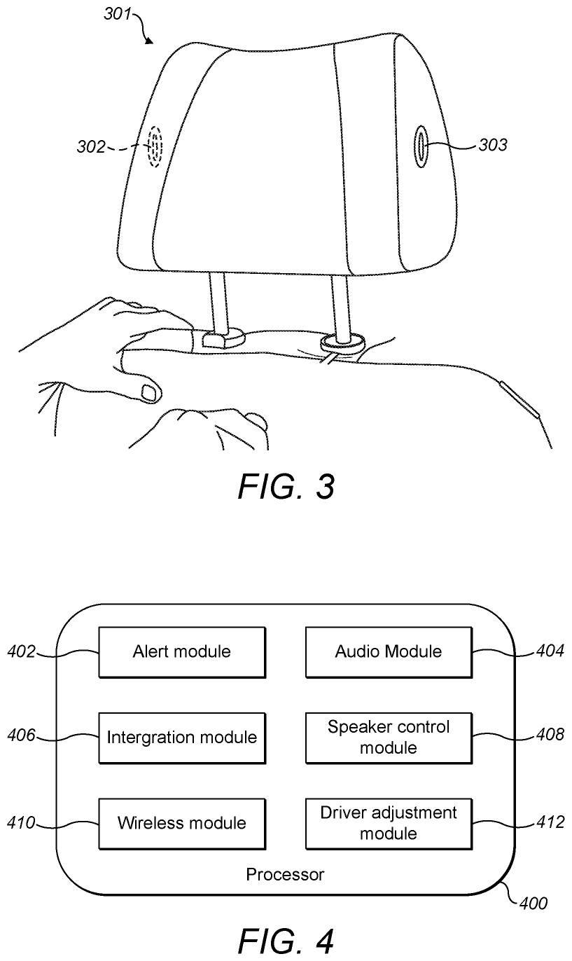

FIG. 3 shows two speakers 303 and 302 situated on either side of the drivers head rest 301. This specific positioning is done in such a way that the driver is able to hear the alert if the speaker is behind him on the right side 303 and the speaker on the left side 302 is making the sound. If the left side of the vehicle is going to encounter any collusion then the left side of the drivers head rest speaker 302 will alert the driver. If there is a collusion about to happen on the right side the ride speaker 303 will alert. This directional sound production enables the driver to get alerted before the driver has a chance to see the side mirrors or rear view mirror or even the busy dashboard. This invention is attached to the sound or audio system of the vehicle and when these speakers are activated to alert the driver the rest of the sound system such music or radio is either reduced in sound or shut off until the alert system indicates the danger has passed or has been overcome. The positional speakers with directional alerts help the driver to focus and not get distracted by watching the dashboard when a general alarm is sounded by lane departure or bar based proximity alerts are sounded. The sounds from the speakers can be modulated to be more or different based on the proximity and danger level in conjunction with alert system of the vehicle or can be independent of the vehicle alert system. The tones of alert can be customized or changed so that they do not alarm the driver. The sound alerts may be coordinated with visuals up on top of the dash board so that the driver's eyes do not have to focus downward and off the street view.

FIG. 4 shows a system residing on a processor or a platform having an alert module 402, an audio module 404, integration module 406, a speaker control module 408, driver adjustment module 412 and a wireless module 410 are described. The modules can be added and scaled to suit the autonomous vehicles, electric vehicles and conventional gas vehicles onboard computer system. The system can be installed as standalone or integrated with existing alert system of the vehicles. Alert module 402 is a part of the computer program that helps audio sound come out of the speaker 303 and 302 of the car seat in FIG. 3. The alert module also collaborates with driver adjustment module and wireless module to collaborate with the lights of the car and change the color depending on the type and proximity of the danger so that the speaker control module and the lights give out the right intensity sound and color to alert the driver. The alert module is specific to sound creation and light control to alert the driver. Speaker control module 408 will alert and scale the level of alert on the speaker and mute other sound systems when there a danger. The audio model 404 integrates with the vehicle sound system and helps modulate the alerts depending on the front danger or the back danger. The wireless module 410 and integration module 406 play a significant role in talking to the main computer of the car and satellite feedback and sync the data for alerts. The integration module is in constant contact with onboard computer system in modern vehicles. The wireless module connects with satellite, cloud services, navigation software's and others to keep the messages current and help integration of communication happen better. Driver adjustment module 412 plays a role in enabling driver to choose the level of sound, number of alert notifications and communicate with the mechanics of the vehicle and safety devices such as air bags. All these modules are stored, operated, processed on a processor 400. The processor 400 can be remotely controlled via satellite, housed on board computer or managed using cloud based architecture.

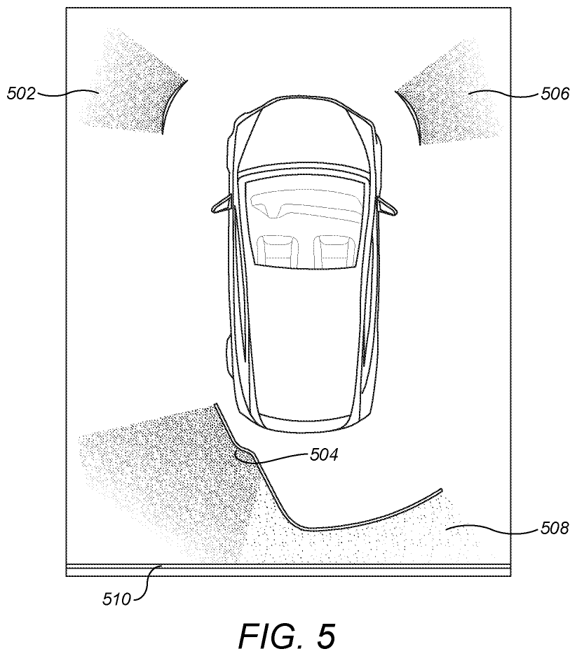

FIG. 5 shows an example of various color alerts around the vehicle with different color intensity to indicate to the driver the risk level. The instant system of audio alerts can mimic the color intensity to noise intensity or variations to alert the driver of the vehicle. For example color 506 is orange as projected by the blubs or by changing color using the software for the existing blubs in the car, color 502 may be green to show the danger is there but need to aware it is close and the color 508 is just white as the distance from the car is the farthest. The combination of color alerts and head set based speakers makes the driver more focused in avoiding accidents. The two sensory modules that do not require for the driver to take his eyes off the road is critical and the instant invention enables the hearing and vision to of the driver to be alerted while their eyes are still on the road instead of looking at the dash board for alerts.

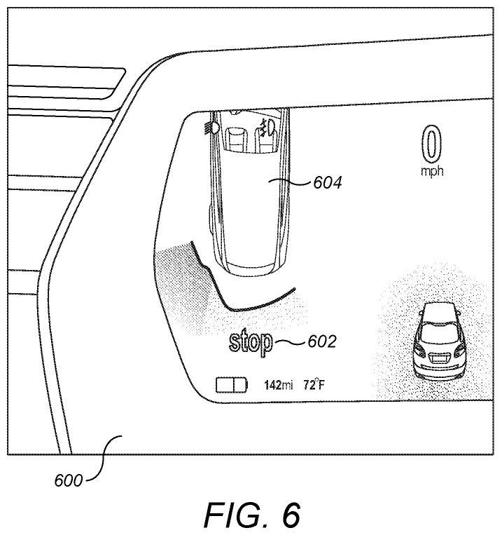

FIG. 6 shows traditional stop sign 602 on the dashboard of the vehicle 604 to alert the driver and shows a picture that makes the driver look at the dashboard 600 to see where the danger is. The instant system for alert using the speakers on the drivers head set or front right or front left would enable the driver to instantly be aware of the direction and alert level.

Accordingly, the specification and drawings are to be regarded in an illustrative rather than a restrictive sense.

What is claimed is:

1. A system for alerting a driver, comprising;
a positional speaker device on the head rest of the driver's seat;
a system to control the speaker either independently or with the computer system of the vehicle; and
a visual color alert with the speaker device alert to the driver to avoid accident

2. The system of claim 1, wherein the system comprises of an alert module, audio module, integration module, speaker control module, wireless module and driver adjustment module.

3. The system of claim 2, wherein the speaker control module adjusts the sound to the right or left side speaker for the alert and reduces the sound from the other sources to emphasize on the danger.

4. The system of claim 2, wherein the alert module is specific to sound creation and light control to alert the driver.

5. The system of claim 2, wherein the integration module is in constant contact with onboard computer system in modern vehicles.
